(19) United States
(12) Patent Application Publication
(10) Pub. No.: US 2003/0084189 A1
(43) Pub. Date: May 1, 2003

(54) Self-defining and self-routing enterprise message

(76) Inventor: Peter Bals, Great Neck, NY (US)

Correspondence Address: John S. Sensny, Scully, Scott, Murphy & Presser, 400 Garden City Plaza, Garden City, NY, 11530, US

(21) Appl. No.: 10/036,039

(22) Filed: Oct. 26, 2001

(51) Int. Cl. G06F 15/16

(52) U.S. Cl. 709/246; 709/201; 709/230

(57) ABSTRACT

A method and system for operating a distributed computing system of the type having a multitude of distributed applications, each of the applications including a procedural part for executing instructions, and a declarative part including data. The method comprises the steps of formatting messages to include processing instructions; and transmitting the messages to the distributed applications, the transmitted messages causing the applications to implement the processing instructions included in the messages. An important advantage of self-defining and self-routing messages is that they may be used to reduce the procedural part of the application program and to make it generic. Customization and tailoring of the application takes place in the design of the declarative part. The procedural part interprets the messages in a generic fashion and executes instructions, such as logic or services, that are declared in the messages.

### COPYRIGHT NOTICE

A portion of the disclosure of this patent document contains material which is subject to copyright protection. The copyright owner has no objection to the facsimile reproduction by anyone of the patent documents or the patent disclosure as it appears in the Patent and Trademark Office patent files or records, but otherwise reserves all copyright rights whatsoever.

### BACKGROUND OF THE INVENTION

1. Field of the Invention

The invention generally relates to message communications in a distributed computing environment. More specifically, the invention relates to self-defining and self-routing enterprise messages.

2. Prior Art

The objects of a software program are comprised mainly of two parts: a procedural part and a declarative part. The procedural part carries out the instructions, and the declarative part contains the data to be acted upon. In a traditional computer program, both the procedural and the declarative parts need to be implemented. The procedural part is typically tailored to the requirements of the application.

Traditionally, the messages that are transmitted to an application are used to transmit data, but do not implement the procedural part of the application. The procedural part of the application could be made smaller and more generic if the messages transmitted to the application are used to help perform the instructions.

### SUMMARY OF THE INVENTION

An object of this invention is to provide a self-defining and self-routing message format.

Another object of the present invention is to reduce the procedural part of an application program, and to make it more generic, by using self-defining and self-routing messages to execute instructions.

A further object of the invention is to use the procedural part of an application program to interpret messages in a generic fashion and to execute instructions that are declared in the messages.

These and other objectives are attained with a method and system for operating a distributed computing system of the type having a multitude of distributed applications, each of the applications including a procedural part for executing instructions, and a declarative part including data. The method comprises the steps of formatting messages to include processing instructions; and transmitting the messages to the distributed applications, the transmitted messages causing the applications to implement the processing instructions included in the messages.

An important advantage of self-defining and self-routing messages is that they may be used to reduce the procedural part of the application program and to make it generic. Customization and tailoring of the application takes place in the design of the declarative part. The procedural part interprets the messages in a generic fashion and executes instructions that are declared in the message.

Self-defining/self-routing messages may be dynamically generated and published to interested subscribers. Subscribers have the ability, via generic procedural components, to interpret the message and execute instructions as described in the message. The invention thus allows for a dynamic execution of application code, and the emphasis of the application design becomes the design of the self-defining/self-routing messages. The instructions included in the messages may be, for example, instructions to perform business logic or services. The instructions may be simple or complex and may, for instance, be instructions to partition the data in a file or to trigger another application.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 depicts a distributed computing environment.

FIGS. 2 and 3 show a preferred embodiment of the message format of the present invention.

### DETAILED DESCRIPTION OF THE PREFERRED EMBODIMENT

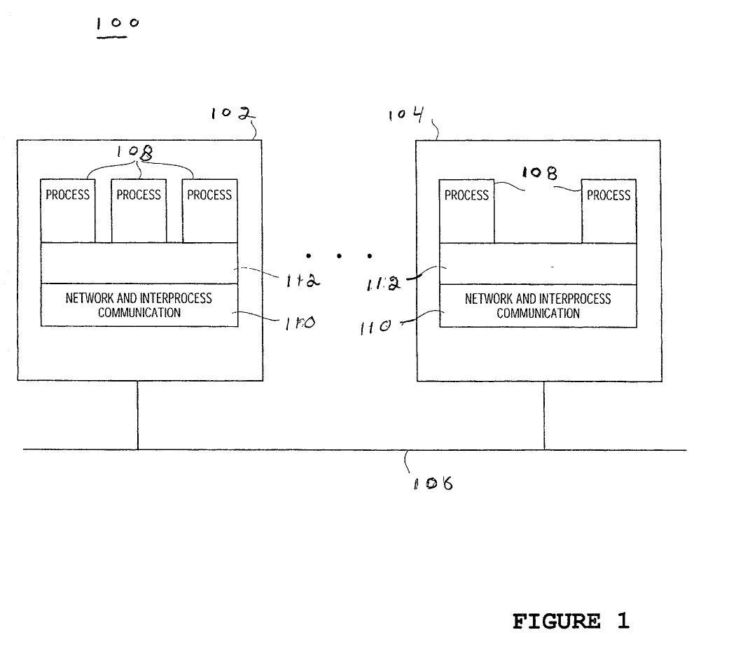

FIG. 1 is a block diagram depicting a distributed application environment 100 in which a plurality of nodes (systems or processors within systems) communicate. More specifically, system 102 and system 104 communicate via communication medium 106. A plurality of processes or applications 108 are distributed among the systems 102 and 104. Each of the applications includes a procedural part for executing instructions, and a declarative part including data. The instructions executed by the procedural parts of the applications may be, for example, business logic or services. The processes 108 and systems 102 and 104 utilize network and interprocess communications services 110 to exchange messages between the various processes. Preferably, each of the processes includes a service 112 to dynamically generate and publish messages exchanged among the processes.

The present invention provides a message, and in particular a message format, for use in this distributed computing environment. Generally, in accordance with this invention, the messages are formatted to include processing instructions. The messages are sent to the distributed applications and cause those applications to implement the processing instructions included in the messages. The instructions included in the messages may be, for example, instructions to perform business logic or services. The instructions may be simple or complex and may, for instance, be instructions to partition the data in a file or to trigger another application.

As mentioned above, the use of messages in this way allows the procedural part of the application programs to be reduced and to be made generic. Customization and tailoring of the application takes place in the design of the declarative part. The procedural part interprets the message in a generic fashion and executes the processing instruction that is declared in the message.

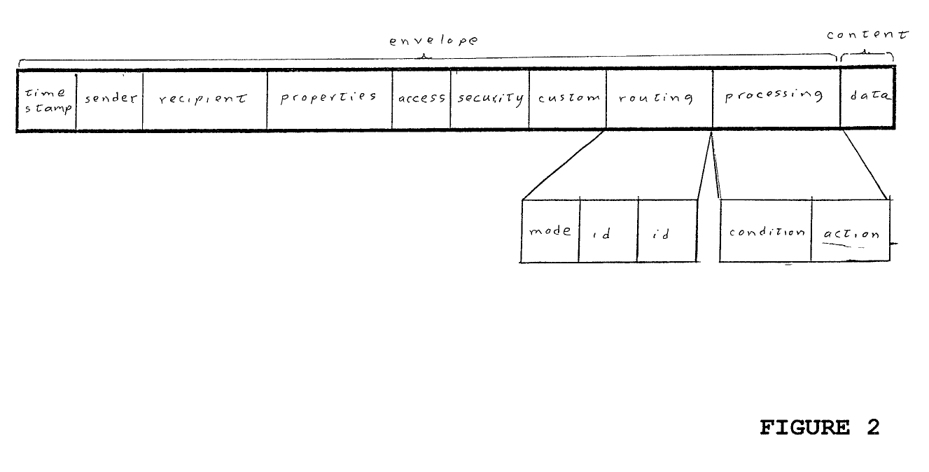

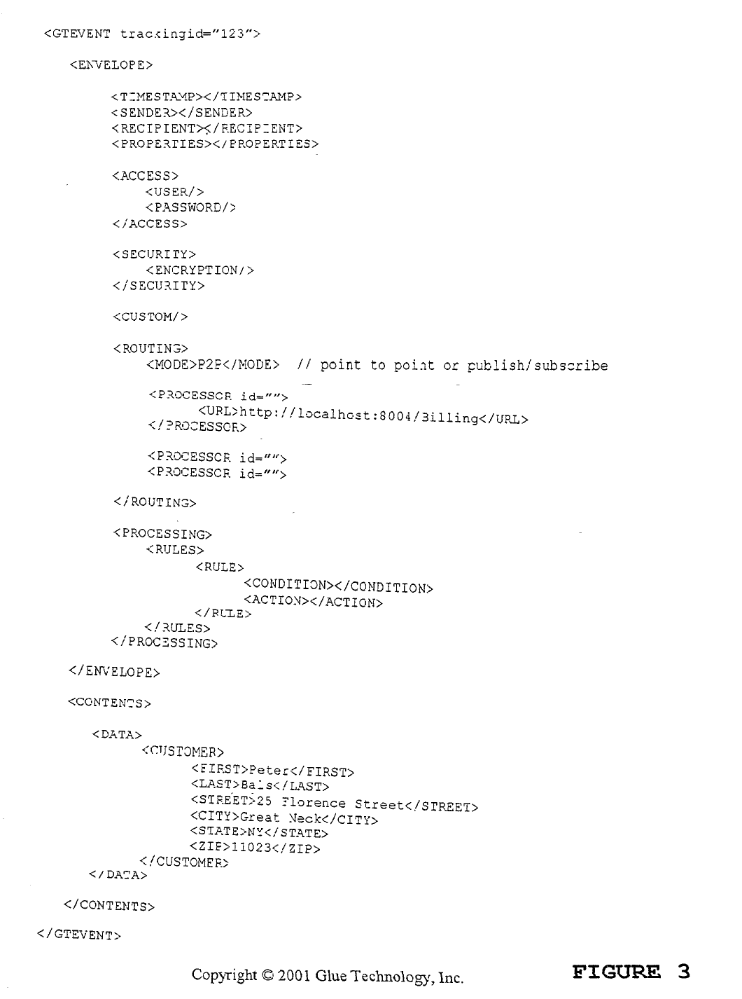

A preferred embodiment of the message format is illustrated in FIGS. 2 and 3, and with reference thereto, this message includes ten fields: timestamp 122, sender 124, recipient 126, properties 128, access 130, security 132, custom 134, routing 136, processing 138, and data 140. The routing field includes a set of sub-fields, and specifically, a mode sub-field 142 and one or more processor id sub-fields 144. Also, the processing field includes two sub-fields: condition 146 and action 148. The first nine fields form the envelope of the message, and the data field forms the content portion of the message.

The time stamp field 122 is used to record the times of certain events. Preferably, when the message is received by an application, the time of receipt is stored in the time stamp field of the message. Also, whenever the message is sent, the time at which it is sent may be recorded in the time stamp field of the message.

The sender field 124 is used to store the names of all the systems that have sent the message. Preferably, whenever a system or application sends the message, the system's name is added to this field, and preferably, these names are added in a defined order. With this information, each recipient of a message can identify all the other systems or applications that have received the message, and preferably in the order in which they received the message.

The recipient field 126 is used to identify the next recipient of the message. Whenever a system wants to send a message to another system, the former puts the name of the latter in this recipient field. The properties field 128 is used to identify any properties of the message that a recipient should be aware of.

The access field 130 may be used to identify the systems or applications that have access to the message. Preferably, this field identifies one or more users, and, for each user, an associated password. In order for a system to receive the message, that system must be on the list of users and must supply the system's password.

The security field 132 is used to store any key that might be needed for decrypting the message. The custom field 134, which is optional, is provided for holding information that does not come within the categories of the other fields. This field provides the message with increased flexibility, and allows a sender to customize a message to fit unique, unusual, or changing circumstances.

The routing field 136 is used to hold data needed to route the message and to identify certain other aspects of the message. More specifically, the mode sub-field 142 identifies the mode of the message. For instance, a message may be a point-to-point message, or a publication in a publish/subscribe system. The processor id sub-fields 144 are used to identify specifically the processor or type of processors that can receive the message. Each processor id sub-field may be associated with a processor field that provides specific instructions or information for the processor identified in the processor id sub-field.

The processor field 138 sets rules for the target or recipient of the message. These rules may be in the form of conditions/actions, set forth in sub-fields 146 and 148, wherein if one or more specified conditions are met, then the specified action is to be taken.

The data field 140 is used to hold data that may be used by the recipient. For instance, as with the example illustrated in FIG. 3, this field may be used to hold a customer name and address.

The preferred message format of this invention may be dynamically generated. Recipients have the ability, via generic procedural components, to interpret the message and execute instructions as described in the message. In this way, the invention allows for a dynamic execution of application code, and the emphasis of the application design becomes the design of the self-defining/self-routing messages.

Also, as will be appreciated by those of ordinary skill in the art, the present invention may be used in a wide range of systems and may be used for a wide range of specific applications. For example, the message format disclosed herein may be used in the publish/subscribe system disclosed in copending application Ser. No. 09/760,930, filed Jan. 16, 2001, for “System and Method For Exchanging Information,” the disclosure of which is herein incorporated by reference in its entirety.

Preferably, as messages are generated and transmitted through and around the distributed computing system 100, information identifying that movement is generated and stored, allowing the users to track the movement of the messages, and preferably this tracking information is kept in a central database to which at least some of the applications have access. For example, when each message is sent by an application, data identifying the message, the time it was sent, and the applicaition sending the message may be sent to and stored in this database.

Also, whenever a message is received by an application, information identifying the message, the application receiving it, and the time of receipt is sent to the database. In this way, as messages are sent around the system 100, applications can, at any time, check to determine where the message is, where it has been, what applications have received it, where the message is going, and what applications will see it, and, preferably, the time at which these events occurs. Additional tracking information may also be stored, such as the names of individuals who have received messages.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

1. A method of operating a distributed computing system of the type having a multitude of distributed applications, each of the applications including a procedural part for executing instructions, and a declarative part including data, the method comprising the steps of:
formatting messages to include processing instructions; and
transmitting the messages to the distributed applications, the transmitted messages causing the applications to implement the processing instructions included in the messages.

2. A method according to claim 1, wherein:
the formatting step includes the step of providing each message with a timestamp field; and
the transmitting step includes the step of, when each application receives one of the messages, said application entering the time of receipt of the message in the time stamp field of the message.

3. A method according to claim 2, wherein the transmitting step includes the further step of, when each application receives one of the messages, said application also entering the time of receipt in a central database accessible to at lease some of the other applications.

4. A method according to claim 1, wherein the formatting step includes the steps of providing each of the messages with a processor id field and a processor instruction field, and including the processing instructions for the intended recipient processor in the processor instruction field of the message.

5. A method according to claim 1, wherein:
the formatting step includes the step of providing each message with a plurality of fields; and
the transmitting step includes the step of, when each application receives one of the messages, the application entering into one of the fields of said one message a unique identification code for the application to indicate that the message has been received by the application.

6. A distributed computing system comprising:
a multitude of distributed applications, each of the applications including a procedural part for executing instructions, and a declarative part including data;
means for formatting messages to include processing instructions; and
transmitting the messages to the distributed applications, wherein the transmitted messages cause the applications to implement the processing instructions included in the messages.

7. A distributed computing system according to claim 6, wherein:
the formatting means includes means for providing each message with a timestamp field; and
each application includes means for entering the time of receipt of one of the messages, in the time stamp field of the message, when the application receives said one of the messages.

8. A distributed computing system according to claim 7, wherein each application also includes means for entering, in a central database accessible to at lease some of the other applications, the time of receipt of said one of the messages when the application receives said one of the messages.

9. A distributed computing system according to claim 6, wherein the formatting means includes means for providing each of the messages with a processor id field and a processor instruction field, and wherein the processing instructions for the intended recipient processor are included in the processor instruction field of the message.

10. A distributed computing system according to claim 6, wherein:
the formatting means includes means for providing each message with a plurality of fields; and
each application includes means for entering into one of the fields of one of the messages a unique identification code, when the application receives said one of the messages, to indicate that said one of the messages has been received by the application.

11. A program storage device readable by machine, tangibly embodying a program of instructions executable by the machine to perform method steps in a distributed computing system of the type having a multitude of distributed applications, each of the applications including a procedural part for executing instructions, and a declarative part including data, the method steps comprising:
formatting messages to include processing instructions; and
transmitting the messages to the distributed applications, the transmitted messages causing the applications to implement the processing instructions included in the messages.

12. A program storage device according to claim 11, wherein:
the formatting step includes the step of providing each message with a timestamp field; and
the transmitting step includes the step of, when each application receives one of the messages, said application entering the time of receipt of the message in the time stamp field of the message.

13. A program storage according to claim 12, wherein the transmitting step includes the further step of, when each application receives one of the messages, said application also entering the time of receipt in a central database accessible to at lease some of the other applications.

14. A program storage device according to claim 11, wherein the formatting step includes the steps of providing each of the messages with a processor id field and a processor instruction field, and including the processing instructions for the intended recipient processor in the processor instruction field of the message.

15. A program storage device according to claim 11, wherein:
the formatting step includes the step of providing each message with a plurality of fields; and
the transmitting step includes the step of, when each application receives one of the messages, the application entering into one of the fields of said one message a unique identification code for the application to indicate that the message has been received by the application.

16. A self-routing, self-defining message, for use in a distributed computing system having a multitude of distributed applications, each of the applications including a procedural part for executing instructions and a declarative part including data, said message comprising a data medium tangibly embodying information, readable by the applications and transmittable over a transmission medium to the applications, and identifying a plurality of fields, one of the fields providing instructions for the applications to perform processing decisions.

17. A self-routing, self-defining message according to claim 16, wherein a second of the fields is a timestamp field for receiving and holding data tangibly embodying information identifying when the message is received by one of the applications.

18. A self-routing, self-defining message according to claim 16, wherein a second of the fields is a processor id field for receiving and holding data tangibly embodying information identifying processors that are to receive the message.
